(19) United States
(12) Patent Application Publication
(10) Pub. No.: US 2010/0165795 A1
(43) Pub. Date: Jul. 1, 2010

(54) Medical device with automatic time and date correction

(75) Inventors: David Elder, Inverness (GB); Raymond Welsh, Fife (GB); Ian Shadforth, Evanton (GB)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: LifeScan Scotland Ltd., Inverness-shire (GB)

(21) Appl. No.: 12/319,018

(22) Filed: Dec. 30, 2008

(51) Int. Cl. G04C 11/02; G04B 47/00

(52) U.S. Cl. 368/10; 368/47

(57) ABSTRACT

Various exemplary embodiments of methods and apparatuses are described and illustrated in which time and date of are provided to a medical device via wireless signals to ensure accurate time keeping by the medical device.

### BACKGROUND

Many diabetic patients use a test meter to closely monitor their blood glucose levels. There are many blood glucose meters commercially available such as the OneTouch® Ultra® blood testing kit, available from LifeScan, Inc., Milpitas, USA. In general, a test meter works in conjunction with a disposable test strip. The test strip can include a sample receiving chamber and at least two electrodes disposed within the sample-receiving chamber in addition to the enzyme (e.g. glucose oxidase) and the mediator (e.g. ferricyanide). In use, a user can prick their finger or other convenient site to induce bleeding and introduce a blood sample to the sample-receiving chamber of a test strip, thus starting the chemical reaction. The test current generated is measured by the test meter and converted into a glucose concentration reading via a simple mathematical formula. The measurement of glucose may be based upon the specific oxidation of glucose by the enzyme glucose oxidase (GO), where the current generated is proportional to the glucose content of the sample.

Applicants believe that it is important for a person with diabetes to know the concentration of glucose in their blood at any given time. For example, the date and time of measured glucose concentrations prior to mealtimes, exercise workouts or driving can immediately influence a user's therapy or diet.

Most commercially available glucose monitoring devices have the time and date setting programmed during manufacture. However, the meter date and time can be incorrect due to drift, corruption, or user error. For example, the date and time can be cleared from the meter when the batteries are discharged or removed. In addition, a user can potentially set the date and time incorrectly when replacing the batteries.

### SUMMARY OF THE DISCLOSURE

In one exemplary embodiment, a method to set a date and time in a medical device to a time zone in which the medical device is located is provided. The medical device includes a microcontroller responsive to blood glucose values and connected to a wireless receiver. The method can be achieved by scanning a predetermined range of frequency values with the wireless receiver, in which at least one frequency value has a wireless signal, the wireless signal having a current date and time information encoded therein; determining a frequency value having a signal strength greater than as compared to any other frequency values in the predetermined range; setting the wireless receiver to the determined frequency value; and synchronizing a clock in the medical device to the current date and time encoded at the determined frequency value. In various alternatives, the scanning on can occur upon a pre-programmed event, which is selected from the group consisting of (i) an installation of a new battery into the medical device, (ii) an activation of the medical device, (iii) a predetermined time of a day, and (iv) a determination of a glucose concentration. The method may include turning off the wireless receiver. The scanning can occur upon physically transforming glucose on a test strip to an enzymatic by-product upon insertion of the test strip into a strip port connector of the medical device. The wireless receiver can be turned on for a duration of less than about 10 seconds before being turned off. The step of turning on the wireless receiver is adjusted to occur at a time interval of about one minute. The method may further include: storing the frequency value having the maximum signal strength in a memory of the medical device; and using the frequency value in the memory without performing the scanning step when the FM receiver is turned on again. The wireless signal may include a FM signal and the wireless receiver may include a FM receiver. The predetermined range of frequency values ranges from about 80 MHz to about 108 MHz. The FM signal comprises a subcarrier frequency of about 57 kHz to carry the current date and time information encoded therein at about 1187.5 bits per second. The FM signal comprises a third harmonic of a pilot tone for FM stereo. The medical device may include a glucose meter or an insulin pump.

In yet another exemplary embodiment, a method for wirelessly setting a date and time in a medical device is provided. The medical device includes a microcontroller coupled to a wireless receiver. The method can be achieved by: determining that a new battery has been installed into the medical device; automatically turning on a wireless receiver in the medical device when there is a determination that the new battery has been installed; receiving a wireless signal with the wireless receiver, the wireless signal comprising a current date and time information encoded therein; synchronizing a clock in the medical device to the wireless signal; and turning off the wireless receiver. The method further includes scanning a predetermined range of frequency values with the wireless receiver; determining a frequency value having a signal strength greater than a predetermined threshold; and setting the wireless receiver to the frequency value having a signal strength greater than the predetermined threshold. Alternatively, the method may include scanning a predetermined range of frequency values with the wireless receiver; determining a frequency value having a maximum signal strength; and setting the wireless receiver to the frequency value having the maximum signal strength. The wireless signal includes a FM signal and the wireless receiver includes a FM receiver, the FM receiver being turned on for a duration of less than about 10 seconds before being turned off. The step of turning on the FM receiver is adjusted to occur at a time interval of about one minute. The method may further include: storing the frequency value having a signal strength greater than the predetermined threshold in a memory of the medical device; and using the frequency value in the memory without performing the scanning step when the FM receiver is turned on again. The method may further include storing the frequency value having the maximum signal strength in a memory of the medical device; and using the frequency value in the memory without performing the scanning step when the FM receiver is turned on again. In a variation, the wireless signal includes a FM signal and the wireless receiver includes a FM receiver, and the predetermined range of frequency values ranges from about 80 MHz to about 108 MHz. The FM signal may include a subcarrier frequency of about 57 kHz to carry the current date and time information encoded therein at about 1187.5 bits per second. The FM signal may include a third harmonic of a pilot tone for FM stereo. The medical device includes a glucose meter or an insulin pump.

In yet another exemplary embodiment, a method for wirelessly setting a date and time in a medical device is provided. The medical device includes a microcontroller responsive to blood glucose values and connected to a wireless receiver. The method can be achieved by: determining that a glucose measurement was performed with the medical device; automatically turning on a wireless receiver in the medical device when there is a determination that the glucose measurement was performed; receiving a wireless signal with the wireless receiver, the wireless signal comprising a current date and time information encoded therein; synchronizing a clock in the medical device to the wireless signal; and turning off the wireless receiver. The method includes physically transforming glucose to an enzymatic by-product.

In yet a further exemplary embodiment, a glucose test meter is provided that includes a circuit, wireless receiver, clock, microprocessor, and display. The circuit is configured to measure a glucose concentration. The wireless receiver is configured to select a wireless signal with a signal strength greater than as compared to any other frequency values in a predetermined frequency range, the wireless signal having encoded information on a current date and time. The microprocessor is configured to turn on the wireless receiver when a glucose measurement is performed with the circuit, and synchronize the clock with the current date and time information encoded by the wireless signal with the strongest signal strength. The display is configured to illustrate a current date and time of a time zone in which the meter is located in with a measured glucose concentration thereon.

In a further exemplary embodiment, a glucose test meter is provided that includes a circuit, wireless receiver, clock, microprocessor, and display. The circuit is configured to measure a glucose concentration. The wireless receiver is configured to select a wireless signal with a signal strength greater than as compared to any other frequency values in a predetermined frequency range, the wireless signal having encoded information on a current date and time. The microprocessor is configured to turn on the wireless receiver when a new battery is installed into the glucose test meter, and synchronize the clock with the current date and time. The display is configured to illustrate a current date and time of a time zone in which the glucose meter is located in with a measured glucose concentration thereon.

In yet another embodiment, a glucose test meter is provided that includes a circuit, wireless receiver, clock, microprocessor, and display. The circuit is configured to measure a glucose concentration. The wireless receiver is configured to select a wireless signal with a signal strength greater than as compared to any other frequency values in a predetermined frequency range and in which the wireless signal has encoded information on a current date and time. The microprocessor is configured to turn on the wireless receiver when a new battery is installed into the glucose test meter, control the circuit, and synchronize the clock with the current date and time information encoded in the wireless signal. The display is configured to illustrate a current date and time therein of a time zone in which the glucose meter is located in with a measured glucose concentration thereon, the display being connected to the microprocessor.

These and other exemplary embodiments, features, advantages will be apparent when taken with reference to the following detailed description of the exemplary embodiments of the invention in conjunction with the accompanying drawings that are briefly described below.

### BRIEF DESCRIPTION OF THE DRAWINGS

The accompanying drawings, which are incorporated herein and constitute part of this specification, illustrate presently preferred exemplary embodiments of the invention, and, together with the general description given above and the detailed description given below, serve to explain features of the invention, in which:

FIG. 1 illustrates a simplified schematic diagram of a system that includes one or more of a medical device and a remote transmitter;

FIG. 2 illustrates a simplified block diagram of the medical device, which includes a wireless receiver chip that enables automatic date and time updates;

FIG. 3 illustrates a simplified circuit diagram of the wireless receiver chip of the medical device of FIGS. 1 and 2 that enables automatic date and time updates;

FIG. 4 illustrates a flow diagram outlining a process to automatically retrieve time and date information that is based on finding a frequency having a maximum signal strength;

FIG. 5 illustrates another flow diagram outlining a process to automatically retrieve date and time information that uses previously saved frequency values;

FIG. 6 illustrates another flow diagram outlining a process to automatically retrieve date and time information that uses a predetermined threshold to find a frequency having sufficient signal strength;

FIG. 7 illustrates another flow diagram outlining a process that uses a predetermined threshold to find a frequency having sufficient signal strength and uses previously saved frequency values;

FIG. 8 illustrates a schematic view of a clock face 500 showing the seconds of a minute in the conventional manner.

### DETAILED DESCRIPTION OF ILLUSTRATIVE EXEMPLARY EMBODIMENTS

The following detailed description should be read with reference to the drawings, in which like elements in different drawings are identically numbered. The drawings, which are not necessarily to scale, depict selected exemplary embodiments and are not intended to limit the scope of the invention. The detailed description illustrates by way of example, not by way of limitation, the principles of the invention. This description will clearly enable one skilled in the art to make and use the invention, and describes several exemplary embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred exemplary embodiment.

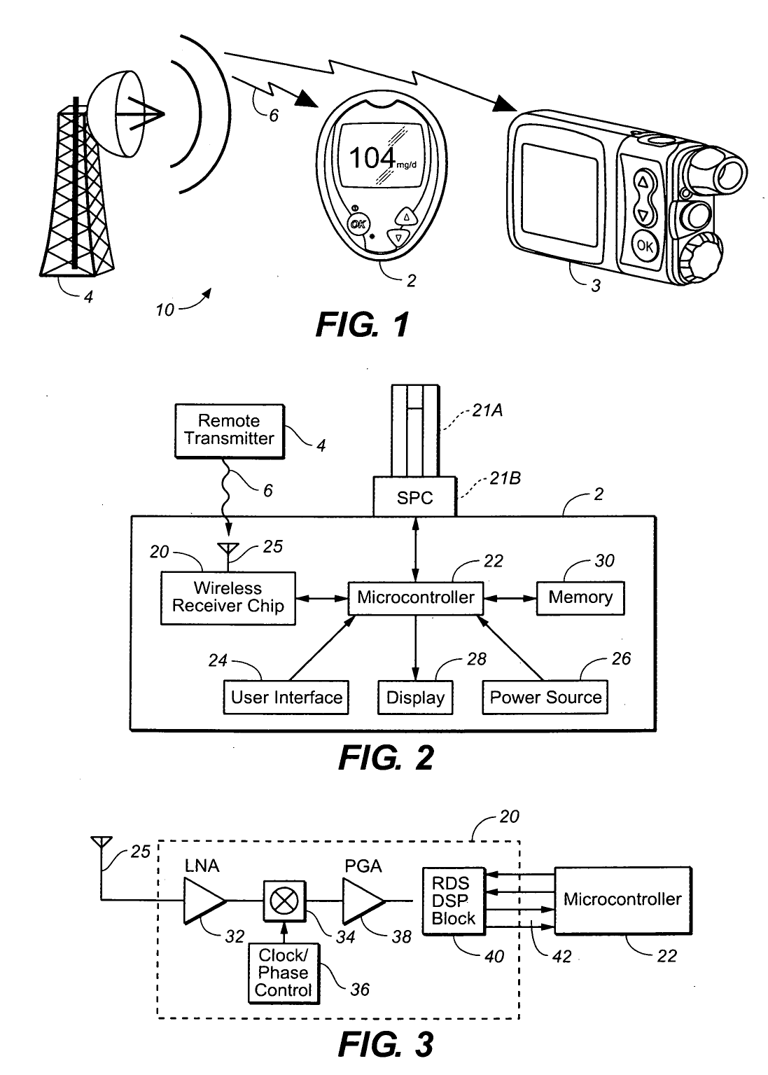

FIG. 1 illustrates an exemplary simplified schematic diagram of an analyte monitoring system 10 including a medical device, which may include a glucose sensor 2 or an insulin infusion pump 3, and a remote transmitter 4. Medical device (sensor 2 or pump 3) can be configured to receive data from remote transmitter 4 via a transmission signal 6. Medical device (sensor 2 or pump 3) may be any device that utilizes blood glucose measurement such as, for example, a blood glucose measurement meter, a remote physiological monitor, or continuous glucose device or an insulin delivery device. Medical device (sensor 2 or pump 3) can be configured to receive a suitable wireless signal, such as, for example, a frequency modulated (“FM”) signal from a remote transmitter 4. Transmitter 4 can be in the form of a FM transmitter that conveys accurate date and time information for the relevant time zone. An internal clock of the medical device (sensor 2 or pump 3) can then be synchronized to the accurate date and time source at predetermined intervals or on specific occasions. In order to be able to analyse and interpret blood glucose measured data reliably, applicants believe it is important that the correct date and time of each individual measurement is stored in the memory of the meter alongside each measurement result. Without the correct date and time information, analyzing a user's glucose concentration trends over time would be virtually impossible. Accordingly, a health care provider (“HCP”) would not be able to prescribe an accurate management regime for the patient based on their glucose concentration trends.

In an exemplary embodiment, a medical device can be configured to synchronize to the current time (CT) component of a frequency modulated (FM) signal to ensure that the medical device has accurate date and time information. The FM signal can in the form of a Radio Data System (RDS) signal where the current time (CT) feature allows synchronization of an internal clock within the receiver, giving accuracy to within 100 milliseconds of UTC (Universal Time Coordinate).

Radio Data System (RDS), also known as Radio Broadcast Data System in the US, was first introduced to address the increasing problem of tuning conventional radios due to the vast number of different frequencies being used to transmit radio programs. RDS is a communications protocol that uses a conventional FM signals to send digital information in addition to the typical analog information for reproducing sound. A 57 kHz sub-carrier is used to carry data at 1187.5 bits per second, and as the third harmonic of the pilot tone for FM stereo, 57 kHz was chosen as it would provide minimal interference with the pilot tone. Details of utilization of the RDS signal are provided in GB2238438, which is hereby incorporated by reference in its entirety. Additional details regarding automatic time setting using RDS are provided in U.S. Pat. No. 7,031,696, which is hereby incorporated by reference in its entirety.

FIG. 2 illustrates an exemplary simplified block diagram of the medical device (sensor 2 or pump 3) of FIG. 1 including the main electronic components that enable automatic date and time updates. Medical device (sensor 2 or pump 3) includes a microcontroller 22, a wireless receiver chip 20, a test strip 21A, a test strip port connector (SPC) 21B, a user interface 24, a power source 26, a display output 28 and a memory 30. Wireless receiver chip may be configured to include an integrated RDS decoder (not shown) and an embedded antenna 25. FIG. 2 also shows wireless communication between medical device (sensor 2 or pump 3) and a remote transmitter 4 via transmission signal 6.

Integrated circuits (IC) are commercially available having an FM receiver and a RDS decoder on the same chip. Chipsets offering RDS capabilities intended for portable devices e.g. mobile phones and MP3 players are commercially available from companies such as Silicon Labs of Austin, Tex., and NXP Semiconductors. Examples include, but are not limited to the Si4705 or Si4706 chips available from Silicon Laboratories, which provide FM digital tuning integrated with a stereo decoder and consume less than 10 mm² of board space. Such a receiver may support worldwide FM frequencies in the range 64 to 108 MHz with adjustable seek parameters. These wireless receivers have an advantage of encompassing an embedded antenna 25, which helps reduce the size of the device. An embedded antenna may be in the form of a PCB trace antenna, wire antenna or loop antenna for example.

Referring again to FIG. 2, the wireless receiver chip 20 can be located on the same circuit board as the other components of the medical device, however, in another exemplary embodiment wireless receiver chip 20 may be located on a separate circuit board alternatively positioned above or below the plane of a first PCB thereby providing an improved antenna design and some noise reduction. A wireless receiver chip can have a relatively high power consumption rate, which is believed to be about ten times higher than that needed for the operation of a typical medical device such as a glucose meter. In an exemplary embodiment, both the glucose meter and the receiver chip may run from a single power source such as, for example, a pair of ‘AA’ batteries. In another exemplary embodiment, one battery can be dedicated to power the glucose meter and a second battery can be dedicated to power the wireless receiver chip. Independent batteries could ensure the normal operation of the medical device, such as enabling a patient to use their glucose meter to test their blood sugar concentrations even if the battery powering the receiver chip has been drained.

FIG. 3 illustrates an exemplary simplified circuit diagram of the wireless receiver component 20 of the medical device of FIGS. 1 and 2, showing the main components that enable automatic date and time updates. FIG. 3 includes an antenna 25, a low noise amplifier (LNA) 32, a synchronous demodulator 34, a clock/phase control unit 36, a programmable gain amplifier (PGA) 38, an RDS digital signal processing (DSP) block 40, and input and output lines 42 connecting to the microcontroller 22. Antenna 25 can be configured to receive a signal from a predetermined frequency range (following one of the tuning protocols described herein for example) that is then amplified by a LNA 32 before being sent to the synchronous demodulator 34. The signal can include RDS data by superimposing a 57 kHz sub-carrier, which is subsequently subtracted by the clock/phase control unit 36 to provide the clean RDS data. The RDS signal is then amplified by the PGA 38 and sent to the DSP block 50 for decoding into a current date and time.

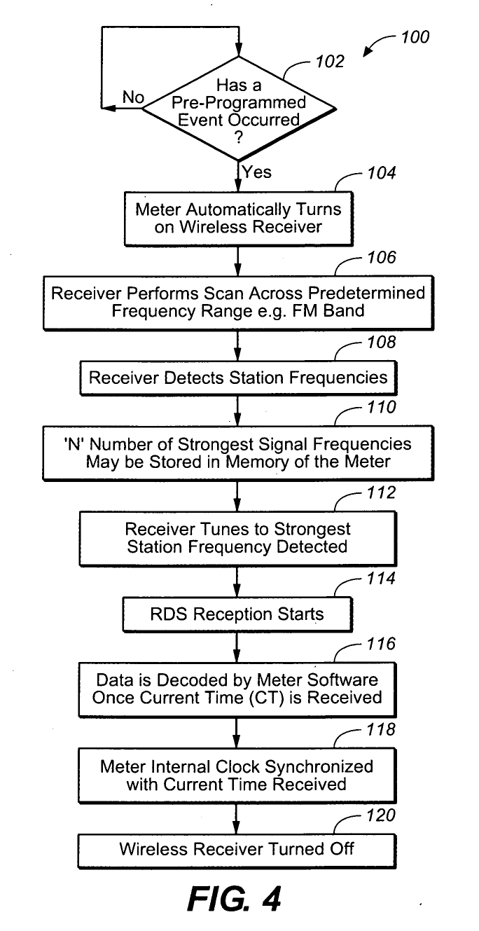

FIG. 4 illustrates an exemplary flow diagram outlining a basic tuning protocol 100 to automatically retrieve time and date information for use within a medical device (sensor 2 or pump 3). Due to the power consumption of the receiver chip, and in the interests of conserving battery power, in one exemplary embodiment the wireless receiver can remain in a sleep mode or turned off for most of the time, only powering up for short periods of time in order to receive current time information.

In an exemplary embodiment, the wireless receiver 20 can be automatically turned on, indicated here by step 104. The process of automatically turning on can occur upon the occurrence of a pre-programmed event 102, such as for example but not limited to, a battery replacement, an activation of the medical device (sensor 2 or pump 3), an occurrence of a predetermined time of day, or an occurrence of a blood glucose measurement being performed. Whilst this list provides some exemplary example events, it is not exclusive and other events are intended to be included. As used herein, the term “automatically” means that a step or a plurality of steps can be initiated due to predetermined occurrence of events or activities without requiring an intended input by the user or operator of the medical device to check or verify the time or date on the medical device.

In an exemplary embodiment, the wireless receiver 20 may be turned on in order to receive current date and time information following replacement of a battery from the medical device. In the short time that it takes a user to replace the battery (i.e., typically 1 to 2 minutes under normal circumstances) the internal clock information may be lost. Upon insertion of a new battery, the software of the medical device would recognize that the battery has been changed and immediately, or at some predetermined time interval after receiving a new battery, instruct the wireless receiver to turn on to obtain updated time and date information following a protocol such as those outlined in FIGS. 4 to 7, and subsequently synchronize the internal clock of the medical device.

In another exemplary embodiment, the receiver IC may be turned on upon activation of the medical device (sensor 2 or pump 3). Many conventional devices such as glucose measurement meters power on upon pressing an ‘on’ or ‘ok’ button or upon detection of a test strip being inserted into the meter in preparation to perform a test. In this exemplary embodiment, the wireless receiver can be configured to turn on as part of the meter's start up protocol, therefore every time the meter is used to perform a measurement or perhaps the patient activates the meter to view previous results, then the receiver may begin the protocol to receive and update the date and time information.

In another exemplary embodiment the wireless receiver can be programmed to turn on and retrieve updated date and time information at one or more predetermined times of day, for example at 12 noon. In another example exemplary embodiment the wireless receiver can be turned on to coincide with each time a measurement such as blood glucose measurement is made. For most patients this would result in several date and time updates every day, ensuring that these settings are highly accurate and therefore allowing better data analysis and trend identification by the HCP.

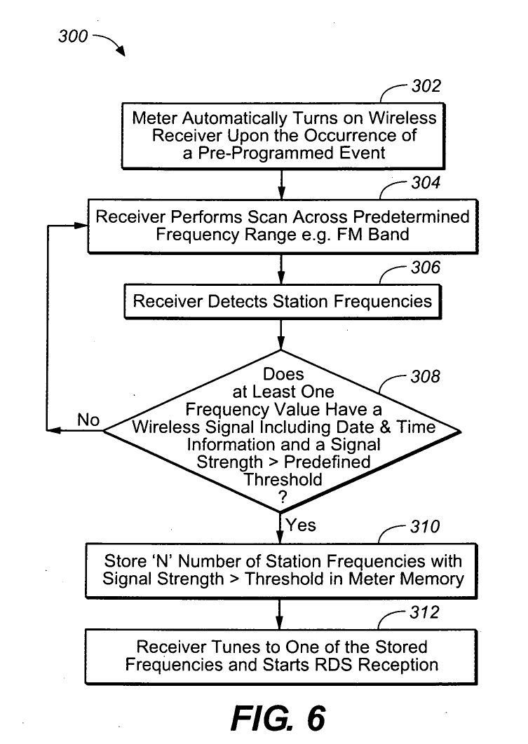

Once powered on, the wireless receiver performs a scan (also known as a sweep or auto-seek) across a predetermined frequency range, as shown by step 106 in which at least one frequency value has a wireless signal. The predetermined frequency range may include the FM frequency band, which ranges from approximately 80 to 108 MHz. The scan may alternatively be in size steps of 100 kHz. As the receiver scans the frequency range it detects all the station frequencies present as shown by step 108, and which may be categorized as having a signal strength greater than a predetermined threshold. In an exemplary, a number of frequency stations exhibiting the strongest signal strengths may be stored in the memory of the device, as shown by step 110, for example as ‘Station 1’, along with ‘N’ number of additional frequencies with strong signals stored as ‘Station 2’ up to ‘Station ‘N’, as will be described in more detail in relation to FIG. 6. The receiver may tune to the frequency with the strongest signal strength detected, as shown by step 112, and begin RDS reception 114 from that frequency. At the reception of Current Time (CT) the data may be decoded 116 by the decoder circuit and then the internal clock of the medical device can be synchronized 118 with the received current time. To conserve battery power, the wireless receiver can then be powered down to sleep mode or turned off, as shown by step 120, until triggered again by the next pre-programmed event that would cause it to power on and retrieve updated time information.

It is intended by applicants that the steps outlined in tuning protocol 100 may be performed in any order and not restricted to the order described. In addition any one or more of the steps may be utilized as needed.

The internal clock of the medical device (sensor 2 or pump 3) may be a ‘real time clock’ (RTC) in the form of an integrated circuit that keeps track of current time with an estimated error of approximately 30 to 40 minutes per year if left unchecked. Software within the meter continues to advance the RTC every second. Once the CT is decoded from the RDS reception then the RTC is synchronized with this current time.

Alternatively, the RDS reception may run with on-screen diagnostics visible to the user. This may be useful when a new meter is switched on for the first time for example as it allows the user to acknowledge that the date and time parameters have been set accurately. Yet in an alternative exemplary embodiment, the RDS reception may run without any screen output i.e. the screen would be blank as if the meter was switched off. In this mode, the user would not have any knowledge of the process being performed by their meter. Additionally, leaving the display powered off has the added advantage of conserving battery power.

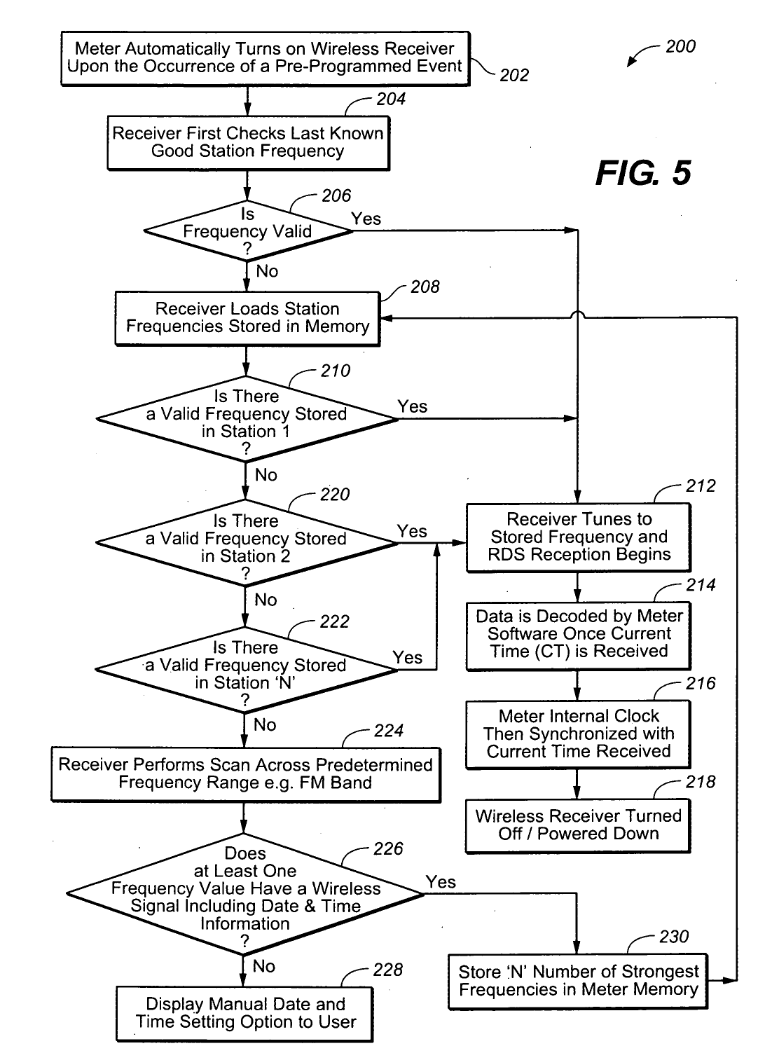

FIG. 5 illustrates an exemplary flow diagram outlining another basic tuning protocol 200 to automatically retrieve date and time information that uses previously saved frequency values. Tuning protocol 200 may be followed for the automatic retrieval of current date and time information to enable synchronization of the internal clock of a medical device (sensor 2 or pump 3) such as a blood glucose meter for example.

Following a power on of the receiver IC upon the occurrence of a pre-programmed event, as shown by step 202, such as one or more of those example events listed and described in relation to FIG. 4, the wireless receiver 20 may first check the last known good station frequency, as shown by step 204. If this frequency is valid, 206, then the receiver may tune directly to this frequency and begin RDS reception, 212.

If however, the last known good frequency is no longer valid at as shown by step 206, then the receiver may access the memory of the medical device and look for any station frequencies previously stored. Any frequencies stored in the memory are then loaded into the receiver, as shown by step 208. The wireless receiver 20 may then determine if there is a first frequency stored in “Station 1” for example, as shown by step 210. If a valid frequency is found, then the receiver may tune to this frequency and begin RDS reception, 212. In one exemplary embodiment, the frequency stored in “Station 1” corresponds to the frequency exhibiting the strongest signal strength during the last scan of the frequency bandwidth. If the frequency stored in Station 1 is not valid, then the receiver may determine if there is a valid frequency stored within “Station 2” for example, as shown by step 220, and may continue this process ‘N’ number of times, as shown by step 222, depending on how many frequencies may be stored. RDS reception begins once a valid station frequency is found and tuned in to. Once the current time (CT) is received, the meter software decodes the data, as shown by step 214, and the internal clock is synchronized with the new, current time, 216. The wireless receiver 20 can then be powered down or turned off to conserve battery power, as shown by step 218.

Programming the receiver to tune directly to a previously stored or preset frequency and not perform a scan of the entire band may reduce the time it takes for new, updated date and time information to be received. If a signal is available at the previously stored frequency then RDS reception can start right away, the current time is received and decoded, then the internal clock of the meter can be synchronized with this new, updated time and the receiver can be turned off. Use of a previously stored frequency allows the entire date and time updating process to be completed within a short time period, for example approximately 2 to 3 seconds. Eliminating the step of scanning the frequency bandwidth and searching for the station frequencies each time updated date and time information is required can reduce the overall time that the wireless receiver 20 is powered on, thereby minimizing battery consumption.

If however, the frequencies stored in the memory of the medical device are no longer valid, for example if the patient has moved location, then the receiver may perform a scan across the predefined frequency band, starting at 88 MHz and advancing to 108 MHz for example, as shown by step 224. If at least one frequency is detected and has a wireless signal having encoded information on date and time information, as shown by step 226, then ‘N’ number of the strongest frequencies can be stored within the memory of the meter, 230, and the tuning procedure can start, as shown by step 212. If the FM signal is very weak and/or no station frequencies are detected then the user may be provided with the option to set the date and time manually, as shown by step 228.

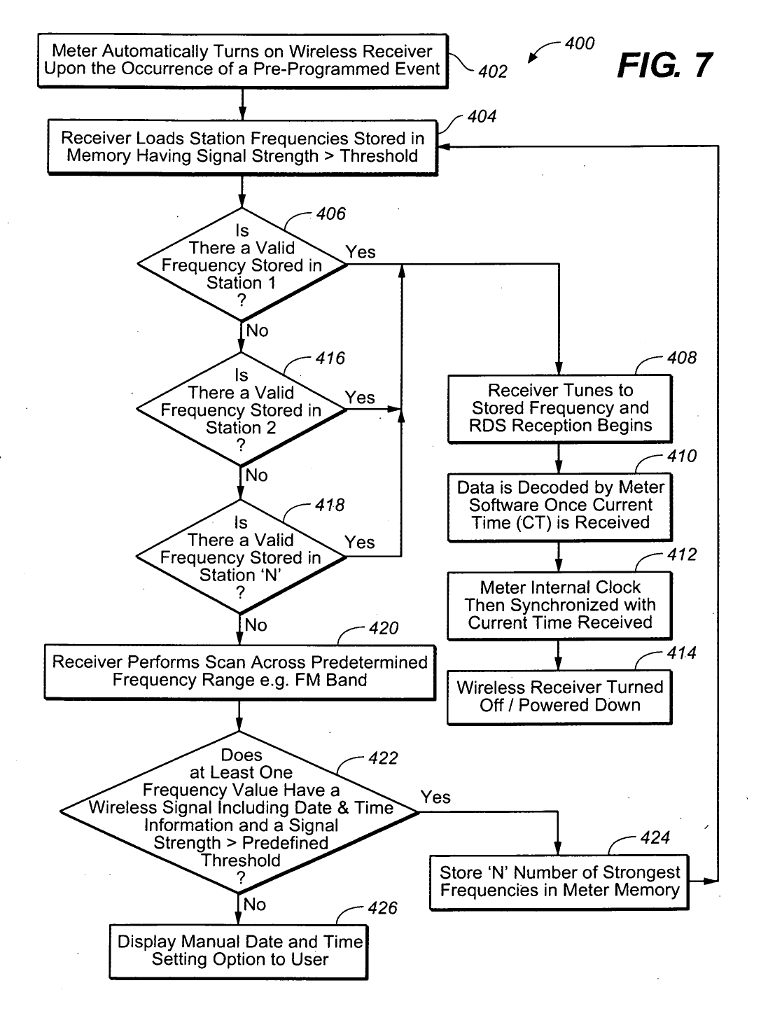

FIG. 6 illustrates an exemplary flow diagram outlining another process 300 to automatically retrieve date and time information that uses a predetermined minimum threshold to find a frequency having sufficient signal strength. In this exemplary embodiment, the medical device automatically turns on the wireless receiver 20 following the occurrence of a preprogrammed event, as shown by step 302, such as battery replacement or a glucose measurement or the like. The wireless receiver 20 may then scan across the predefined frequency range 304, detecting the station frequencies present 306. If at least one frequency value has a wireless signal having encoded information on date and time information, and the signal strength is greater than the predetermined minimum threshold value stored in the memory of the device, as shown by step 308, then the receiver may tune to one of the stored frequency values and begin the RDS reception, as shown by step 312. Alternatively, ‘N’ number of station frequencies having a signal strength exceeding the predetermined threshold value may be stored in the memory of the meter, as shown by step 310, and used in accordance with the protocol described in FIG. 7. The frequency with the strongest strength may be stored in “Station 1” for example, and the second strongest in “Station 2” etc. up to ‘N’ number of stations.

FIG. 7 illustrates an exemplary flow diagram outlining another process 400 that uses a predetermined threshold to find a frequency having sufficient signal strength and uses previously saved frequency values in order to retrieve current date and time information encoded therein. In this exemplary embodiment, preferably following a power on, as shown by step 402, the wireless receiver 20 may be programmed to first access the memory of the medical device, as shown by step 404, and search for frequency values previously stored having signal strengths greater than a predetermined minimum threshold strength, as shown by step 406. If the frequency stored in “Station 1” is found to be valid, then the receiver may tune directly to that frequency and begin RDS reception, as shown by step 408. If the signal available from the previously stored frequency is strong enough and sufficient to enable RDS reception then RDS reception would begin immediately, and once the current time information is received and decoded 410, then the internal clock of the meter can be synchronized 412, and the wireless receiver 20 can be powered off or resume a ‘sleep’ mode, as shown by step 414.

If, however, the signal from the previously stored frequency “Station 1” is not available or sufficient to enable RDS reception then the receiver may check the frequency stored in “Station 2”, as shown by step 416, and so on up to ‘N’ number of different station frequencies previously stored in the meter memory, 418. If none of the previously stored frequency values yield a valid signal from which to begin RDS reception, then the wireless receiver 20 may be commanded to perform a scan across the predetermined frequency range, 420. The wireless receiver 20 will search for stations having a frequency value with a wireless signal having encoded information on date and time information and having a signal strength exceeding a predefined threshold signal strength value, as shown by step 422. ‘N’ number of station frequencies having a signal strength greater than the predefined threshold value may then be stored in the memory of the meter for subsequent use, 424. The receiver may then tune to one of the stored frequency values and begin RDS reception. Once the current time information is received, the data is decoded and the internal clock of the meter synchronized with the new, updated date and time information prior to the receiver being turned off. Alternatively, if no FM signal is available then the user may be provided with the option to update the time and date information manually, as shown by step 426.

Storing the station frequencies identified as having the strongest signal strengths, or alternatively exceeding a predefined threshold strength value, reduces the number of processes the wireless receiver 20 has to perform in order to obtain current date and time information encoded therein. Less processes steps to perform will typically correlate to a reduction in the length of time the receiver is required to be powered on, therefore power consumption is kept to a minimum. For many people, their general geographic location may not change a great deal from day to day, therefore having the option for the meter to remember the frequency of the station previously tuned into to obtain RDS date and time information provides several advantages. Such advantages include potentially increased processor performance as well as reduced power consumption, ultimately leading to an increased battery lifetime and hence more reliable date and time information available to the patient and their HCP for use in the managing of the patient's condition. Accurate date and time information allows trends and patterns in a patient's historical measurement data to be reliably identified and analyzed, and may lead to improved care for the patient.

FM signals, in most atmospheric conditions, do not travel long distances, and may also be affected by large obstructions such as built-up areas or hills for example. Therefore many transmitters are required to provide adequate signal coverage. If a patient travels locally within a radius of 100 km for example, then the receiver may need to re-tune to a different frequency to obtain the strongest signal in the new location. Neighbouring transmitters may also use different FM frequencies to avoid interference. In an exemplary embodiment, the wireless receiver 20 would scan the frequency band and detect the local station frequencies without requiring any user intervention. Operation of the receiver may be completely invisible to the user.

If the user does travel to a different country or location having a different time zone from where they normally reside, then the wireless receiver 20 would be able to scan the frequency bandwidth to detect the stations having the strongest signals, alternatively with a strength exceeding a predefined threshold value, and tuning in to that frequency to receive the RDS information. Furthermore, the current time (CT) is always transmitted in universal time (UTC) that is the same throughout the world, and in addition a local offset is also transmitted depending in which time zone the reception has occurred. Therefore when a blood glucose reading has taken place, the UTC and local offset can be stored along with the glucose result, ensuring that any time differences between glucose readings are maintained despite movement of the patient across time zones. It is intended that the exemplary tuning protocols provided herein may be used either individually or they may be used in combination with one-another.

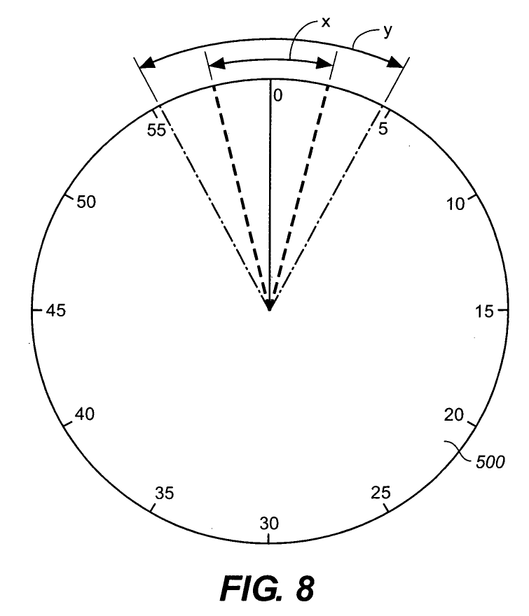

FIG. 8 illustrates an exemplary schematic view of a clock face 500 showing the seconds of a minute in the conventional manner. FIG. 8 also includes a first time period ‘x’ and a second time period ‘y’. The timing accuracy of the meters internal real time clock will depend on the quality of the crystal oscillator it uses as its time base. A typical crystal has a frequency error of approximately ±20 ppm that translates into approximately ±1.7 seconds per day. Whilst a crystal having a frequency error of approximately ±70 ppm translates into approximately ±6 seconds per day. The current time (CT) data within the RDS data is transmitted only once per minute, typically when the seconds of one minute roll over from 59 to 00, therefore powering on the wireless receiver 20 may be delayed until just a few seconds prior to the estimated CT transmission. This reduces the waiting time for the CT data from close to one minute down to only a few seconds.

Referring back to FIG. 8, the first time period ‘x’ in which the receiver circuit may be powered up to receive RDS reception including the CT is shown. First time period ‘x’ may be in the region of 4 seconds, centered around the turnover from 59 seconds to 00, to ensure that the transmission of CT is captured. Time period ‘x’ comprises 2 seconds either side of the turnover from 59 seconds to 00 to allow for a drift of ±1.7 seconds i.e. corresponding to one day since the last CT update and a crystal frequency error approximately ±20 ppm. Similarly, if two days have passed since the last RDS time and date update, then the receiver may be powered on for the duration of second time period ‘y’ that may, in this example, be equal to approximately 8 seconds (i.e. 4 seconds either side of ‘00’). If however the crystal frequency error was closer to ±70 ppm, then first time period ‘x’ may be approximately 12 seconds in duration, and second time period ‘y’ may be closer to 24 seconds. If the date and time has not been updated for several days, then the receiver will be required to power on for greater than one minute in order to ensure capture of the CT transmission. Such specific timing for powering on the wireless receiver 20 aims to reduce the overall duration in which the wireless receiver 20 is powered on, thereby minimizing power consumption and hence extending the lifetime of the battery.

Applicants believe that an advantage is provided in that the time and date setting of a patient's medical device can be completely automatic and hence invisible to the user. Incorrect time and date setting can be a source of complaint from users. This may be due to the complexity of configuring the meter, or understanding the need to check and possibly update these settings. Automatically updating the time and date setting using FM RDS wireless reception virtually eliminates this source of error, and provides the HCP with reliable data allowing easier and better monitoring of the patients historical measured results, which may lead to improved regulation and care for the patient.

A further advantage provided by automatic time and date setting using FM RDS is the possibility to design a meter that has no user operable buttons, i.e., completely button-less. If there is no requirement for the user to enter information or set any parameters such as time, date or calibration code for example, then the possibility exists to provide the patient with an extremely easy to use meter that has no buttons. Those with reduced dexterity may particularly appreciate this type of meter as they may find it very difficult or virtually impossible to navigate through settings and options using the small buttons provided on many conventional monitoring meters. Analysis of measurement data, such as averages and graphs of results, would still be possible by both the patient and/or the HCP using the software available for use on a computer (such as a diabetes management software provided by LifeScan Inc.).

While preferred exemplary embodiments of the present invention have been shown and described herein, it will be obvious to those skilled in the art that such exemplary embodiments are provided by way of example only. For example, the invention can be applied not only to glucose meters, but can also be applied to any medical device such as insulin infusion pump, continuous glucose monitoring system and the like. Numerous variations, changes, and substitutions will now occur to those skilled in the art without departing from the invention. Various alternatives to the exemplary embodiments of the invention described herein may be employed in practicing the invention. It is intended that the following claims define the scope of the invention and that methods and structures within the scope of these claims and their equivalents be covered thereby.

What is claimed is:

1. A method for setting a date and time in a medical device to a time zone in which the medical device is located, the medical device having a microcontroller responsive to blood glucose values and connected to a wireless receiver, the method comprising:
scanning a predetermined range of frequency values with the wireless receiver, in which at least one frequency value has a wireless signal, the wireless signal having a current date and time information encoded therein;
determining a frequency value having a signal strength greater than as compared to any other frequency values in the predetermined range;
setting the wireless receiver to the determined frequency value; and
synchronizing a clock in the medical device to the current date and time encoded at the determined frequency value.

2. The method of claim 1, in which the scanning on occurs upon a pre-programmed event, which is selected from the group consisting of
(i) an installation of a new battery into the medical device,
(ii) an activation of the medical device,
(iii) a predetermined time of a day, and
(iv) a determination of a glucose concentration.

3. The method of claim 1 further comprising turning off the wireless receiver.

4. The method of claim 1, in which the scanning occurs upon physically transforming glucose on a test strip to an enzymatic by-product where the test strip is coupled to a strip port connector of the medical device.

5. The method of claim 1, in which the wireless receiver is turned on for a duration of less than about 10 seconds before being turned off.

6. The method of claim 2, in which the step of turning on the wireless receiver is adjusted to occur at a time interval of about one minute.

7. The method of claim 1 further comprising:
storing the frequency value having a signal strength greater than as compared to any other frequency values in the predetermined range in a memory of the medical device; and
setting the wireless receiver to the stored frequency value without performing the scanning step when the FM receiver is turned on again.

8. The method of claim 1, in which the wireless signal includes a FM signal and the wireless receiver includes a FM receiver.

9. The method of claim 8, in which the predetermined range of frequency values ranges from about 80 MHz to about 108 MHz.

10. The method of claim 9, in which the FM signal comprises a subcarrier frequency of about 57 kHz to carry the current date and time information encoded therein at about 1187.5 bits per second.

11. The method of claim 10, in which the FM signal comprises a third harmonic of a pilot tone for FM stereo.

12. The method of claim 1, in which the medical device includes a glucose meter.

13. The method of claim 1, in which the medical device includes an insulin pump.

14. A method for wirelessly setting a date and time in a medical device including a microcontroller coupled to a wireless receiver, the method comprising:
determining that a new battery has been installed into the medical device;
automatically turning on a wireless receiver in the medical device when there is a determination that the new battery has been installed;
receiving a wireless signal with the wireless receiver, the wireless signal comprising a current date and time information encoded therein;
synchronizing a clock in the medical device to the wireless signal; and
turning off the wireless receiver.

15. The method of claim 14 further comprising:
scanning a predetermined range of frequency values with the wireless receiver;
determining a frequency value having a signal strength greater than a predetermined threshold; and
setting the wireless receiver to the frequency value having a signal strength greater than the predetermined threshold.

16. The method of claim 14 further comprising:
scanning a predetermined range of frequency values with the wireless receiver;
determining a frequency value having a maximum signal strength; and
setting the wireless receiver to the frequency value having the maximum signal strength.

17. The method of claim 14, in which the wireless signal includes a FM signal and the wireless receiver includes a FM receiver, the FM receiver being turned on for a duration of less than about 10 seconds before being turned off.

18. The method of claim 17, in which the step of turning on the FM receiver is adjusted to occur at a time interval of about one minute.

19. The method of claim 15 further comprising:
storing the frequency value having a signal strength greater than the predetermined threshold in a memory of the medical device; and
setting the wireless receiver to the stored frequency value without performing the scanning step when the FM receiver is turned on again.

20. The method of claim 16 further comprising:
storing the frequency value having a signal strength greater than as compared to any other frequency values in the predetermined range in a memory of the medical device; and
setting the wireless receiver to the stored the frequency value without performing the scanning step when the FM receiver is turned on again.

21. The method of claim 17, in which the wireless signal includes a FM signal and the wireless receiver includes a FM receiver, and the predetermined range of frequency values ranges from about 80 MHz to about 108 MHz.

22. The method of claim 21, in which the FM signal comprises a subcarrier frequency of about 57 kHz to carry the current date and time information encoded therein at about 1187.5 bits per second.

23. The method of claim 22, in which the FM signal comprises a third harmonic of a pilot tone for FM stereo.

24. The method of claim 14, in which the medical device includes a glucose meter.

25. The method of claim 14, in which the medical device includes an insulin pump.

26. A method for wirelessly setting a date and time in a medical device including a microcontroller responsive to blood glucose values and connected to a wireless receiver, the method comprising:
determining that a glucose measurement was performed with the medical device;
automatically turning on a wireless receiver in the medical device when there is a determination that the glucose measurement was performed;
receiving a wireless signal with the wireless receiver, the wireless signal comprising a current date and time information encoded therein;
synchronizing a clock in the medical device to the wireless signal; and
turning off the wireless receiver.

27. The method of claim 26, in which the determined glucose measurement includes physically transforming glucose to an enzymatic by-product.

28. A glucose test meter comprising:
a circuit configured to measure a glucose concentration;
a wireless receiver configured to select a wireless signal with a signal strength greater than as compared to any other frequency values in a predetermined frequency range, the wireless signal having encoded information on a current date and time;
a clock;
a microprocessor configured to turn on the wireless receiver when a glucose measurement is performed with the circuit, and synchronize the clock with the current date and time information encoded by the wireless signal with the strongest signal strength; and
a display configured to illustrate a current date and time therein of a time zone in which the meter is located in with a measured glucose concentration thereon, the display being connected to the microprocessor.

29. A glucose test meter comprising:
a circuit configured to measure a glucose concentration;
a wireless receiver configured to select a wireless signal with a signal strength greater than as compared to any other frequency values in a predetermined frequency range, the wireless signal having encoded information on a current date and time;
a clock;
a microprocessor configured to turn on the wireless receiver when a new battery is installed into the glucose test meter, control the circuit, and synchronize the clock with the current date and time information encoded in the wireless signal; and
a display configured to illustrate a current date and time therein of a time zone in which the glucose meter is located in with a measured glucose concentration thereon, the display being connected to the microprocessor.
